(19) United States
(12) Patent Application Publication
(10) Pub. No.: US 2018/0238485 A1
(43) Pub. Date: Aug. 23, 2018

(54) Pipe and Clamp Assembly

(71) Applicant: Pridgeon & Clay, Inc., Grand Rapids, MI (US)

(72) Inventors: Daniel J. Bostwick, Grandville, MI (US); Gregory S. Cowham, Alto, MI (US); William M. Kanouse, Rockford, MI (US); Michael D. Kozal, Caledonia, MI (US); Brent J. Piselli, Muir, MI (US); Peter R. Wojtas, Grand Rapids, MI (US)

(73) Assignee: Pridgeon & Clay, Inc., Grand Rapids, MI (US)

(21) Appl. No.: 15/899,513

(22) Filed: Feb. 20, 2018

Related U.S. Application Data
(60) Provisional application No. 62/461,046, filed on Feb. 20, 2017.

(51) Int. Cl. F16L 55/178; F16L 55/172

(52) U.S. Cl. CPC F16L 55/178; F16L 55/172

(57) ABSTRACT

A pipe assembly includes a pipe body having a longitudinal axis and an axial end with a first radius, at least one relief slot in the pipe body extending from the axial end, and a deformable bridge, wherein a compressive clamping force on the axial end will cause the deformable bridge to deform.

### CROSS REFERENCE TO RELATED APPLICATIONS

This application claims the benefit of U.S. Provisional Application Ser. No. 62/461,046 filed Feb. 20, 2017, which is incorporated herein by reference in its entirety.

### BACKGROUND OF THE INVENTION

Tubular members can be joined or connected by mechanical connectors, such as clamps or clamping devices. Band clamps are commonly used for connecting pipes, hoses, and other tubular members together, such as exhaust pipes of an automotive exhaust system. Such connections may be utilized for a telescopic overlap joint or end-to-end butt joint of two tubular members.

### BRIEF SUMMARY

In one aspect, the disclosure relates to a pipe assembly including a pipe body having a longitudinal axis and an axial end with a first radius, at least one relief slot in the pipe body extending from the axial end, and a deformable bridge spanning the at least one relief slot. A compressive clamping force on the axial end will cause the deformable bridge to deform as it absorbs the compressive clamping force on the axial end and opposite sides of the at least one relief slot are urged toward each other to reduce the radius.

In another aspect, the disclosure relates to a pipe and clamp assembly including a tubular pipe body having a longitudinal axis and an axial end defining an axial opening of the tubular pipe body with a first radius from the longitudinal axis, at least one relief slot arranged at a circumference of the axial end, a deformable bridge spanning the at least one relief slot, and a clamp mechanism configured to surround the axial end and apply a clamping force to compress the axial end that reduces the first radius of the axial opening. The clamping force, when applied, causes the deformable bridge to deform as it absorbs the clamping force, urging opposite sides of the at least one relief slot to move toward each other, reducing the first radius.

### BRIEF DESCRIPTION OF THE DRAWINGS

In the drawings:

FIG. 1 is an isometric view of a tubular pipe with compression relief slots, in accordance with various aspects described herein.

FIG. 2 is an isometric view of the tubular pipe of FIG. 1 mechanically connected with a second tubular pipe by a clamp, in accordance with various aspects described herein.

FIG. 3 is another isometric view of the tubular pipes and clamp of FIGS. 1 and 2, illustrating an assembled, but unclamped, configuration, in accordance with various aspects described herein.

FIG. 4 is the isometric view of FIG. 3, wherein the clamp mechanically connects the tubular pipes, in accordance with various aspects described herein.

### DETAILED DESCRIPTION OF THE DRAWINGS

Aspects of the disclosure relate to a tubular member that can be clamped around another tubular member. To be effective, the connection between the tubular members should provide a suitable fluid-tight seal to prevent leakage. The connection should also have a high degree of mechanical strength and be capable of easy disassembly.

As used herein, the terms “axial” or “axially” refer to a dimension along a longitudinal axis of the pipe. As used herein, the terms “radial” or “radially” refer to a dimension extending between a center longitudinal axis, an outer circumference, or a circular or annular component disposed relative to the longitudinal axis. All directional references (e.g., radial, axial, upper, lower, upward, downward, left, right, lateral, front, back, top, bottom, above, below, vertical, horizontal, clockwise, counterclockwise, inner, outer) are only used for identification purposes to aid the reader's understanding of the disclosure, and do not create limitations, particularly as to the position, orientation, or use thereof. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order and relative sizes reflected in the drawings attached hereto can vary.

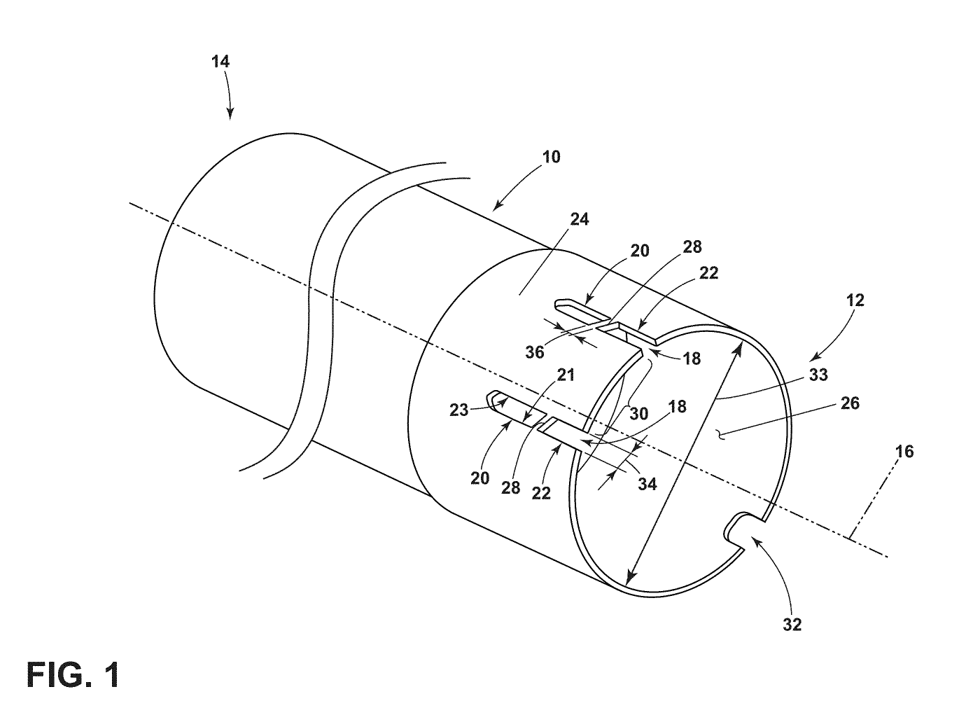

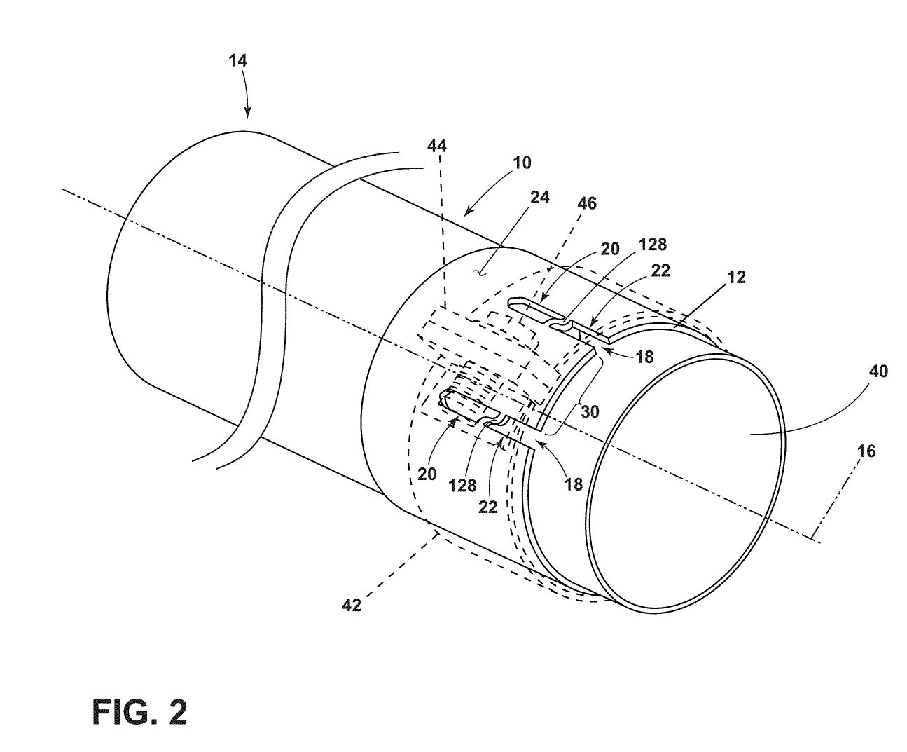

FIG. 1 illustrates an isometric view of a generally tubular first pipe 10 having a first end 12 and an opposing second end 14. It will be understood that the first pipe 10 can have any suitable length and shape. In the illustrated example, the first end 12 includes a centerline (shown in dotted line longitudinal axis 16) extending axially along at least a portion of the first pipe 10. As shown, the first end 12 can be slightly larger, or have a slightly larger radius, compared with the second end 14, or any other portion of the first pipe 10 for that matter. The first end 12 radius can be configured to receive a corresponding second pipe 40 (FIG. 2) within the first end 12.

Non-limiting aspects of the first pipe 10 can include a generally metallic construction, such as iron, aluminum, or an alloy, such as stainless steel, wherein the construction is at least partially malleable or deformable. Non-metallic constructions that are at least partially malleable or deformable are also contemplated. Aspects of the disclosure can be included wherein the first pipe 10 can comprise a portion of a larger assembly, such as a vehicle exhaust system comprising an exhaust manifold, a muffler, a tailpipe, and other components which are not germane to the invention and are not shown in the drawings.

At least one relief slot 18 can be located in the first pipe 10 at the first end 12. In the illustrated example, two relief slots 18 have been illustrated as being included and are shown as being spaced from each other along the circumference of the first pipe 10. The spacing about the circumference of the first pipe 10 is denoted as numeral 30 of FIG. 1. Each relief slot 18 can include first and second apertures 20, 22 or through openings, extending radially inward from an outer surface 24 of the first pipe 10 to an inner surface 26 of the first pipe 10. In the illustrated example configuration, the second aperture 22 can be disposed, located, arranged, or the like, closer or more proximate to an axial end at the first end 12 of the first pipe 10, compared with the first aperture 20. Also as shown, the first and second apertures 20, 22 can be axially aligned along the first pipe 10. The first and second apertures 20, 22 can be separated by a bridge 28 spanning or connecting opposing sides 21, 23 of the apertures 20, 22 and at least partially supporting the aperture 20, 22 spacing. In one non-limiting aspect of the bridge 28, the bridge 28 can extend across the opposing sides of the apertures 20, 22 at an angle of 32 degrees relative to the axial direction of the apertures 20, 22 or of the first pipe 10 (i.e. relative to the longitudinal axis 16).

The radial or angular width 34 of at least one of the first or second apertures 20, 22, along the circumference of the first pipe 10, can be based or dependent upon the first pipe 10 size itself. The sizing can also be based or dependent upon the material construction of the first pipe 10. For instance, in one non-limiting aspect, the first pipe 10 can have a 0.0762 meter (3 inch) diameter 33, and comprise a stainless steel construction. In this example, both the first and second apertures 20, 22 can have a width 34 of 0.0053 meters.

In another non-limiting aspect of the disclosure, the bridge 28 configuration can be based or dependent upon the first pipe 10 size itself, or based or dependent upon the material construction of the first pipe 10. For example, in the first pipe 10 configuration mentioned above, the bridge 28 can be configured to have a width 36 (defined normal to the bridge 28 extension) of 0.003 meters. Additionally, in the example configuration described above, the angular spacing 30 between the illustrated relief slots 18 can 0.038 meters, as measured from the opposing outer edges of the second apertures 22.

In another non-limiting aspect of the disclosure, the width 36 of the bridge 28 or the width 34 of the first or second apertures 20, 22 can be selected, arranged, configured, or the like, based at least in part on a desired clamping strength, a desired compression, a desired deformation, or a combination thereof, to be applied to the first end 12 of the first pipe 10. In yet another non-limiting aspect of the disclosure, the width 36 of the bridge 28 or the width 34 of the first or second apertures 20, 22 for a first relief slot 18 can be selected, arranged, configured, or the like, based at least in part on relative configuration of a width 36 of the bridge 28 or the width 34 of the first or second apertures 20, 22 of another relief slot 18. In yet another non-limiting aspect of the disclosure, the first and second apertures 20, 22 can have varying widths 34.

The first pipe 10 can also include a keyed notch 32, shown on the opposing circumferential side of the first end 12 from the relief slots 18. The keyed notch 32 can be selected, arranged, configured, or the like, such that another pipe received within the first end 12 of the first pipe 10, and having a corresponding key tab, is radially or angularly aligned for proper or desired connecting or clamping.

FIG. 2 illustrates an isometric view of the first pipe 10 axially receiving a second pipe 40, and connected with the second pipe 40 by way of an example clamping mechanism 44. The clamping mechanism 44 is illustrated in dotted outline for ease of understanding. The first pipe 10 can be configured, for instances, to mate with the second piped 40 by way of a telescoping overlap joint.

As shown, the clamping mechanism 44 can include a band 42 radially extending about the outer surface 24 of the first pipe 10, and a compression mechanism, illustrated as a screw 46, screw and nut, or another mechanical fastener, operably configured to compress the band 42 along the radial outer surface 24 of the first pipe 10. The compression of the band 42 by the screw 46 can be selected or configured to ensure or operably prevent or limit the axial or angular movement of the first pipe 10 relative to the second pipe 40. The compression can effectively reduce the radius of the first pipe 10 relative to the second pipe 40 such that the friction interference between the respective pipes 10, 40 prevents or limits the aforementioned relative movements.

As shown, under the compression of the clamping mechanism 44, the bridge (illustrated in a compressed configuration 128) can become deformed in the circumferential direction as the opposing circumferential sides of the first aperture 20, second aperture 22, or relief slots 18 are drawn together by the compression or clamping force of the clamping mechanism 44. As used herein, “deform” can denote any form of bending, alteration, or malleable movement of the bridge 28, 128 relative to the first pipe 10. Stated another way, as the clamping mechanism 44 compresses the first pipe 10 about the second pipe 40, the relief slots 18, the first aperture 20, the second aperture 22, or a combination thereof, narrow in the circumferential direction, and the bridge 128 contorts in the narrowing relief slots 18. At least one of the relief slots 18 or the bridge 28, 128 can be configured to purposely deform, without breaking (e.g. snapping, ripping, or otherwise rupture or become discontinuous) under the desired clamping force to provide adequate clamping of the first pipe 10 to the second pipe 40. In one example configuration, the desired clamping force can be defined as 55 Newton-meters of torque applied to the screw 46. The desired clamping force can be based on, for instance, the first pipe 10, second pipe 40, relief slot 18, or bridge 28, 128 configuration or construction to deform, but not break.

Non-limiting aspects of the disclosure can be included wherein the clamping mechanism 44, such as the band 42, can extend axially to fully overlap an entirety of the first apertures 20 and a portion of the second apertures 22. In this sense, when the clamping mechanism 44 clamps the first and second pipes 10, 40 together, the clamping force of the band 42 over the first aperture 20 creates a fluid-tight seal of the first aperture 20. The fluid-tight seal between the first aperture 20 and the band 42 can prevent gas or fluid leakage from the interior of the first or second pipes 10, 40 to the exterior of the first or second pipes 10, 40. In one example, the fluid-tight seal can be referred to as an “air dam.” In one non-limiting aspect of the disclosure, the integrity of the fluid-tight seal can be at least partially dependent on the intended, desired, or predefined deformation of the bridge 28, 128 to deform without breaking, which would otherwise prevent the fluid-tight sealing between the first pipe 10 and the band 42. Aspects of the disclosure can be included wherein the band 42 can extend over the second aperture 22, but such extension is not necessary.

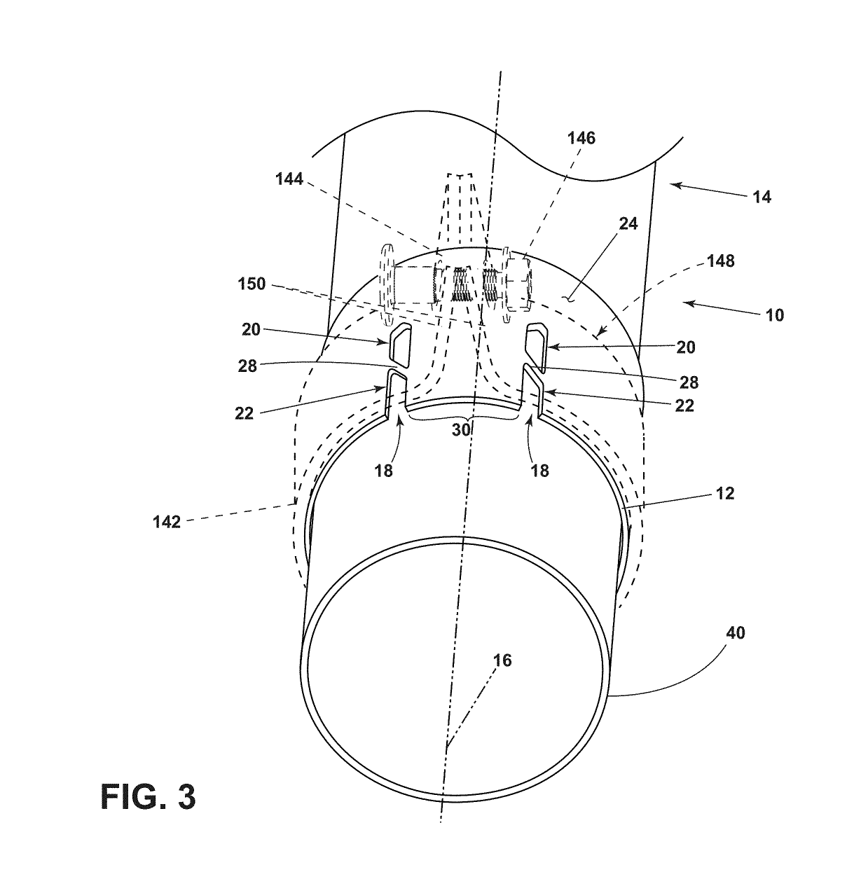

FIG. 3 illustrates an alternative clamping mechanism, 144 for the first pipe 10 and the second pipe 40. The connection of FIG. 3 is similar to the connection illustrated in FIG. 2 therefore, like parts will be identified with like numerals increased by 100, with it being understood that the description of the like parts of the earlier disclosure applies to FIG. 3, unless otherwise noted.

One difference is FIG. 3 illustrates another non-limiting example clamping mechanism 144, illustrated in an unclamped (i.e. non-compressing) configuration. As shown, the clamping mechanism 144 can include a band 142 radially extending about the outer surface 24 of the first pipe 10, and a compression mechanism, illustrated as a screw 146, screw and nut, or the like, operably configured to compress the band 142 along the radial outer surface 24 of the first pipe 10.

The band 142 can additionally include a substantially semi-circular band portion 148 (relative to the longitudinal axis 16) having opposing end arms 150 configured to interface with the screw 146 by way of angling, lifting, or “peeling” away from the outer surface 24 of the first pipe 10 within the axial spacing 30 portion between the relief slots 18. In this sense, the substantially semi-circular portion 148 of the band 142 that overlies the correspondingly circular outer surface 24 and the first aperture 20 such that clamping of the clamping mechanism 144 relative to the first pipe 10 fluidly seals the first pipe 10 to the second pipe 40, as described above. In this sense, non-limiting aspects of the disclosure can be included wherein at least one of the clamping mechanism 144, band 142, or angular spacing 30 can be selected, arranged, configured, disposed, or the like such that the band 142 includes a substantially semi-circular portion 148 that overlies the first apertures 20 and the bridges 128 to create the fluid-tight seal described herein when the appropriate clamping force is applied.

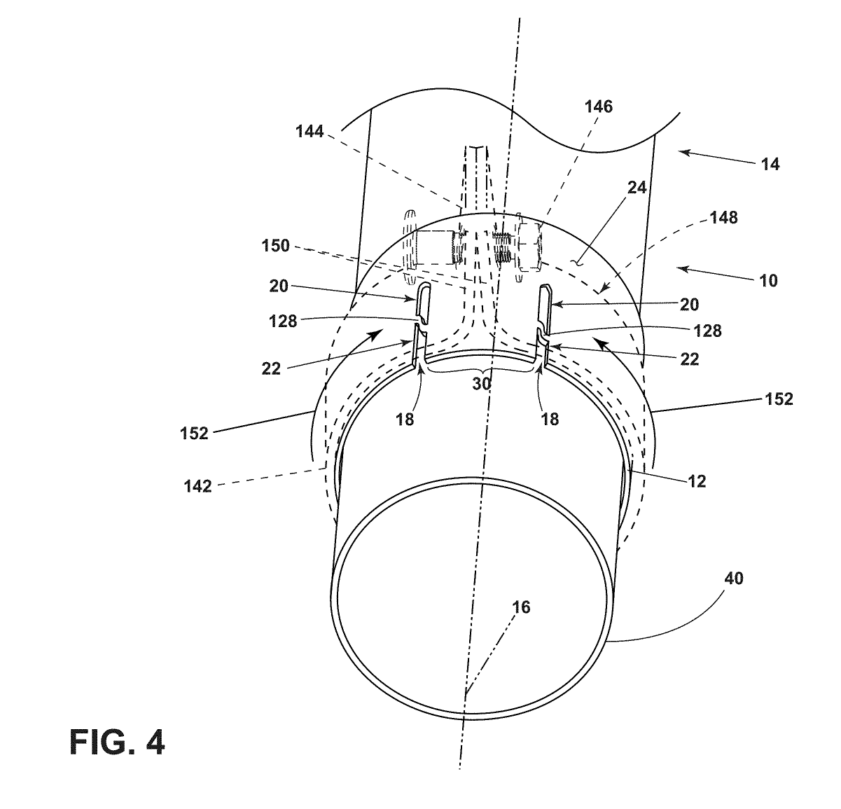

FIG. 4 illustrates the connection of FIG. 3, wherein the clamping mechanism 144 is in a clamped (i.e. compressing or compressive) configuration. As shown, aspects of the disclosure can be included wherein the act of clamping the clamping mechanism 144 can effectively or operably draw the band 142 about the outer surface 24 of the first pipe 10 toward the clamping mechanism 144. The drawing of the band 142 about the outer surface 24 of the first pipe 10 toward the clamping mechanism 144 is illustrated as arrows 152. The amount, quantity, degree, or aspect of movement 152 can correspond to the desired, intended, or preconfigured deforming of the bridge 28, 128.

Many other possible aspects and configurations in addition to that shown in the above figures are contemplated by the present disclosure. The embodiments disclosed herein provide clamping configuration between a first pipe and a second pipe, wherein the first pipe includes an intentionally deformable portion that is deformed during clamping. The deformation of the deformable portion allows for compression of the first pipe relative to the second pipe. The deformation of the deformable portion also allows for a fluid-tight seal between the interior of the first pipe and the exterior of the second pipes. While a “fluid-tight” seal is described herein, aspects of the disclosure can be included wherein the seal is substantially fluid-tight, but not perfectly sealed. In this non-limiting instance, some gaseous leakage can be included, for example, relative to a threshold leakage value, range, tolerance, or the like.

To the extent not already described, the different features and structures of the various embodiments can be used in combination with each other as desired. That one feature cannot be illustrated in all of the embodiments is not meant to be construed that it cannot be, but is done for brevity of description. Thus, the various features of the different embodiments can be mixed and matched as desired to form new embodiments, whether or not the new embodiments are expressly described. Combinations or permutations of features described herein are covered by this disclosure.

This written description uses examples to disclose embodiments of the invention, including the best mode, and also to enable any person skilled in the art to practice embodiments of the invention, including making and using any devices or systems and performing any incorporated methods. The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

While aspects of the disclosure have been specifically described in connection with certain specific embodiments or configurations thereof, it is to be understood that this is by way of illustration and not of limitation. Reasonable variation and modification are possible within the scope of the forgoing disclosure and drawings without departing from the spirit of the disclosure.

What is claimed is:

1. A pipe assembly, comprising:
a pipe body having a longitudinal axis and an axial end with a first radius;
at least one relief slot in the pipe body extending from the axial end; and
a deformable bridge spanning the at least one relief slot
wherein a compressive clamping force on the axial end will cause the deformable bridge to deform as it absorbs the compressive clamping force on the axial end and opposite sides of the at least one relief slot are urged toward each other to reduce the radius.

2. The pipe assembly of claim 1 wherein the relief slot is generally parallel with the longitudinal axis.

3. The pipe assembly of claim 2 wherein the deformable bridge separates a first aperture proximate the axial end form a second aperture space away from the axial end, and the second aperture relative to the first aperture is disposed parallel with the longitudinal axis.

4. The pipe assembly of claim 1 wherein the axial end is sized to receive a second pipe body having a second radius, and the compressive clamping force reduces the first radius to the second radius.

5. The pipe assembly of claim 4 wherein the bridge is configured to deform such that the reduction of the first radius to the second radius creates a fluid seal between the pipe body and the second pipe.

6. The pipe assembly of claim 1 wherein the pipe body is circular in cross section, and wherein the at least one relief slot is arranged at a circumference of the axial end.

7. The pipe assembly of claim 6 wherein the axial end is sized to receive another circular pipe, and wherein the deformable bridge is configured to deform in response to a clamping force such that the axial end radius is reduced about the another pipe.

8. The pipe assembly of claim 1 wherein first and second apertures have opposing sides spaced along a perimeter of the pipe body, and wherein the bridge connects the opposing sides.

9. The pipe assembly of claim 8 wherein the span of the bridge connecting the opposing sides forms an angle relative to the longitudinal axis.

10. The pipe assembly of claim 9 wherein the angle is 32 degrees.

11. A pipe and clamp assembly, comprising:
a tubular pipe body having a longitudinal axis and an axial end defining an axial opening of the tubular pipe body with a first radius from the longitudinal axis;
at least one relief slot arranged at a circumference of the axial end;
a deformable bridge spanning the at least one relief slot; and
a clamp mechanism configured to surround the axial end and apply a clamping force to compress the axial end that reduces the first radius of the axial opening;
wherein the clamping force, when applied, causes the deformable bridge to deform as it absorbs the clamping force, urging opposite sides of the at least one relief slot to move toward each other, reducing the first radius.

12. The pipe and clamp assembly of claim 11 including at least two relief slots circumferentially spaced from one another.

13. The pipe and clamp assembly of claim 12 wherein the clamp mechanism includes a band radially extending about an outer surface of the axial end and a compression mechanism configured to compress the band along the outer surface.

14. The pipe and clamp assembly of claim 13 wherein the compression mechanism is arranged radially between the at least two relief slots.

15. The pipe and clamp assembly of claim 11 wherein the bridge is configured to deform in a circumferential direction such that another pipe received inside the axial end is limited in movement relative to the axial end.

16. The pipe and clamp assembly of claim 11 wherein the relief slot is parallel with the longitudinal axis.

17. The pipe and clamp assembly of claim 16 wherein the at least one relief slot further includes a first aperture and a second aperture, and wherein the position of the second aperture relative to the first aperture is parallel with the longitudinal axis.

18. The pipe and clamp assembly of claim 17 wherein first and second apertures have opposing sides spaced along a perimeter of the tubular pipe body, and wherein the bridge connects the opposing sides.

19. The pipe and clamp assembly of claim 18 wherein the bridge is configured to deform such that a space between the opposing sides of at least one of the first or second apertures narrows.

20. The pipe and clamp assembly of claim 18 wherein the span of the bridge connecting the opposing sides forms an angle relative to the longitudinal axis.
